(19) United States
(12) Patent Application Publication
(10) Pub. No.: US 2026/0364644 A1
(43) Pub. Date: Nov. 19, 2026

(54) FOAM NOZZLE CLEANING APPARATUS AND METHOD FOR CLEANING WAFER SURFACE

(71) Applicant: Taiwan Semiconductor Manufacturing Company, Ltd., Hsinchu (TW)

(72) Inventors: Chi-Hsiang SHEN, Tainan (TW); Te-Chien HOU, Kaohsiung (TW); Jeng-Chi LIN, Hsinchu (TW); Jui Yu PAI, Taoyuan (TW); Kei-Wei CHEN, New Taipei (TW); Hui-Chi HUANG, Zhubei (TW); Chih Hung CHEN, Hsinchu (TW); Tang-Kuei CHANG, Tainan (TW)

(73) Assignee: Taiwan Semiconductor Manufacturing Company, Ltd., Hsinchu (TW)

(21) Appl. No.: 19/753,975

(22) Filed: Jul. 24, 2026

Related U.S. Application Data
(62) Division of application No. 18/936,204, filed on Nov. 4, 2024.

(51) Int. Cl. B08B 3/02; B05B 7/00; B08B 1/12; B08B 1/20; B08B 5/02

(52) U.S. Cl. CPC B08B 3/02; B05B 7/0018; B08B 1/12; B08B 1/20; B08B 5/02

(57) ABSTRACT

The present disclosure relates to a foaming nozzle apparatus and method of cleaning a semiconductor wafer surface with a foaming cleaning agent. One or more foaming nozzle apparatuses can be included in a semiconductor processing chamber for cleaning debris from wafer surfaces.

### RELATED APPLICATION

The present application is a Divisional application of U.S. patent application Ser. No. 18/936,204 filed on Nov. 4, 2024, the entire content of which is incorporated herein by reference.

### BACKGROUND

The processing of wafers to manufacture semiconductor devices includes multiple steps such as etching and cleaning processes to form features of the semiconductor device on the wafers. The etching processes involve the removal of material either directly from the wafers or layers formed on the wafers. The etching processes leave behind residual material which is removed during the cleaning processes. However, as the dimensions of semiconductor devices continue to scale down, trace amounts of debris or contaminants remaining behind in the trenches and vias are becoming increasingly difficult to remove. Some of the debris or contaminants are small particles.

Conventional cleaning methods use wet spray and dispense methods in which the semiconductor substrate is rotated and a spray force is used to produce shear stress and turbulent flow for cleaning the debris or contaminants from sidewalls and bottoms of trenches and vias. Brushes can be used to scrub the surfaces of the wafer during cleaning to facilitate the removal of the contaminants. Wet spray cleaning methods, however, have their shortcomings. Feature patterns with a small pitch (e.g., less than 20 nm) can be easily collapsed by a strong shear force and a high wafer rotation rate. Further, the efficiency of removing debris or contaminants at the bottoms and/or on the sidewall of high aspect ratio trenches and vias may be very low. Remaining debris or contaminants can lead to corrosion on the wafer which reduces yield.

Moreover, conventional wet spray cleaning methods can be expensive in that they consume large amounts of cleaning chemicals. During wet spray cleanings, the chemical leaves the wafer surface very quickly, especially when the wafer is vertically oriented during cleaning operations. Therefore, a large amount of the chemicals need to be sprayed onto the wafer during cleaning, which can increase costs.

Accordingly, a need exists for an improved wafer cleaning method that does not have the shortcomings of traditional wet cleaning methods.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIGS. 1, 2, 3, and 4 are examples of a foaming nozzle apparatus in accordance with some embodiments of the present disclosure.

FIGS. 5A, 5B, 5C, 5D, 5E, and 5F illustrate examples of wafer cleaning with the foaming nozzle apparatus according to embodiments of the present disclosure.

FIGS. 6A and 6B illustrate examples of a wafer cleaning operation with the foaming nozzle apparatus according to other embodiments of the present disclosure.

FIG. 7 illustrates an example of a cleaning operation with the foaming nozzle apparatus installed in a polishing chamber according to an embodiment of the present disclosure.

FIG. 8 illustrates an example of a cleaning operation with the foaming nozzle apparatus installed in a polishing chamber according to another embodiment of the present disclosure.

FIGS. 9A, 9B, 9C, 9D, 9E, 9F, 9G, 9H, 9I, 9J, 9K, 9L, 9M, 9N, 9°, 9P, 9Q, and 9R illustrate examples of nozzle apertures of the foaming nozzle apparatus according to embodiments of the present disclosure.

FIG. 10 is a flowchart illustrating a cleaning method using the foaming nozzle apparatus in accordance with an embodiment of the present disclosure.

FIG. 11 is a flowchart illustrating a cleaning method using the foaming nozzle apparatus in accordance with another embodiment of the present disclosure.

### DETAILED DESCRIPTION

It is to be understood that the following disclosure provides many different embodiments, or examples, for implementing different features of the present application. Specific embodiments or examples of components and arrangements are described below to simplify the present disclosure. These are, of course, merely examples and are not intended to be limiting. For example, dimensions of elements are not limited to the disclosed range or values but may depend upon process conditions and/or desired properties of the device. Moreover, the formation of a first feature over or on a second feature in the description that follows may include embodiments in which the first and second features are formed in direct contact, and may also include embodiments in which additional features may be formed by interposing the first and second features, such that the first and second features may not be in direct contact. Various features may be arbitrarily drawn in different scales for simplicity and clarity. In the accompanying drawings, some layers/features may be omitted for simplification.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. In addition, the term “made of” may mean either “comprising” or “consisting of.” Further, in the following fabrication process, there may be one or more additional operations in between the described operations, and the order of operations may be changed. In the present disclosure, the phrase “at least one of A, B and C” means either one of A, B, C, A+B, A+C, B+C or A+B+C, and does not mean one from A, one from B, and one from C, unless otherwise explained.

As the dimensions of semiconductor devices scale down, the significance of enhanced cleaning efficiency and effective removal of debris and contaminants becomes more important. Debris and contaminants, as well as the corrosion resulting from unwanted debris and contaminants, adversely impact pattern processing and, as a result, fewer percentages of wafers pass circuit probe testing, thereby decreasing yield.

Embodiments of the present disclosure enhance cleaning efficiency and reduce corrosion of wafer surfaces by utilizing a nozzle apparatus that supplies a cleaning chemical in the form of foam. The application of the foaming cleaning agent allows for a rapid, uniform distribution of the cleaning chemical across the entirety of the wafer surface(s). Moreover, due to the consistency of foam, the foaming cleaning agent remains on the surface(s) of the wafer for longer periods of time to enhance cleaning results. The foaming cleaning agent clings to surfaces better than liquid cleaning agents. Moreover, smaller amounts of the cleaning chemical are used since the foaming cleaning agent is able to remain on the surface(s) of the wafer for longer periods of time compared to conventional liquid chemicals sprayed on the wafer. In other embodiments, the foaming cleaning agent acts as a barrier to block oxygen from interacting with the surface(s) of the wafer during the cleaning process which helps reduce corrosion from forming on the wafter surface(s).

The foaming nozzle apparatus of the present disclosure helps reduce defects and corrosion as a result of debris or contaminants not sufficiently removed from the surface(s) of the wafer during cleaning. In some cleaning processes, benzotriazole (BTA), a corrosion inhibitor, is included in the cleaning solution for wafer cleaning. However, conventional wet spray techniques may not entirely remove BTA from wafer surfaces during cleaning which can also lead to patterning defects. The foaming nozzle apparatus of the present disclosure enhances cleaning efficiency by providing a foaming chemical that enhances the removal of BTA or other corrosion inhibitors from wafer surface(s).

Apparatuses and methods for performing a foam cleaning of the surface(s) of wafers and wafer processing equipment are provided in accordance with various exemplary embodiments. The variations of some embodiments are discussed. Throughout the various views and illustrative embodiments, like reference numbers are used to designate like elements.

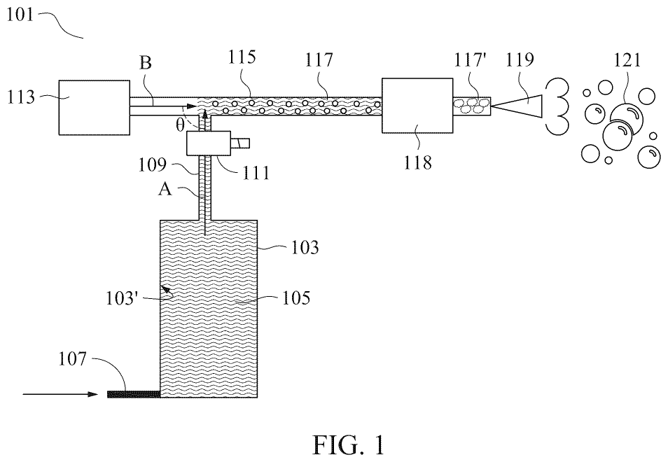

FIG. 1 is a schematic view of a part of a foaming nozzle apparatus 101 in accordance with some embodiments of the present disclosure. In some embodiments, the foaming nozzle apparatus 101 is used to clean a wafer after a polishing process such as chemical mechanical polishing (CMP). In some embodiments, the foaming nozzle apparatus 101 is used to perform a cleaning to remove residue or contaminants, such as organic matter, metallic impurities, oxides, and abrasive slurry particles, from surfaces of the wafer (including the polished wafer surface and backside surface), so that the surfaces are ready for subsequent steps in a fabrication process. The wafer may be a production wafer or a test wafer made of silicon or other semiconductor materials. In other embodiments, the foaming nozzle apparatus 101 is used to clean surfaces of wafer processing equipment disposed in a cleaning or polishing chamber.

As shown in FIG. 1, the foaming nozzle apparatus 101 includes a storage container 103 for storing a cleaning chemical 105 in a liquid state. A supply of the cleaning chemical 105 is provided to the storage container 103 at an input 107. The cleaning chemical 105 flows out of the storage container 103 through an output 109, as shown by the directional arrow A. In certain embodiments, the storage container 103 is made of a polymer or metal material. In some embodiments, the polymer material includes polytetrafluoroethylene (PTFE) or polyvinyl chloride (PVC). In other embodiments, a wear-resistant coating is applied to the inner surface 103′ of the storage container 103. For example, a silicon carbide coating is applied to the inner surface 103′ of the storage container 103 to protect against corrosion caused by the cleaning chemical 105 in some embodiments. In other examples, a PTFE, silicon carbide (SiC), or quartz coating is applied to the inner surface 103′ of the storage container 103 to provide corrosion resistance.

In some embodiments, the storage container 103 is operably connected to a heating source (not shown) to ensure that the cleaning chemical 105 is maintained at a temperature above room temperature during the operation of the foaming nozzle apparatus 101. In one example, the cleaning chemical 105 is heated by a heater to a temperature between 25 C and 80 C. In other embodiments, the cleaning chemical 105 is heated to a temperature between 40 C and about 60 C. In certain embodiments, with the increased temperature of the cleaning chemical, the efficiency of the foaming cleaning process is enhanced.

In certain embodiments, the cleaning chemical 105 is a solution containing at least one surfactant. Foam stability is increased by surfactants that resist drainage of the liquid film around the foam bubble, a process that results in eventual rupture. A balance of forces is reached where the drainage stops at a certain film thickness. In certain embodiments, the surfactant is selected from anionic surfactants, cationic surfactants, nonionic surfactants, amphoteric surfactants, or silicone-based surfactants. In some examples, the cleaning chemical includes one or more surfactants suitable for foaming. In certain embodiments, the surfactant includes poly(vinyl alcohol), isopropyl alcohol, or poly(ethyleneimine).

In other embodiments, the cationic surfactant includes one or more of a quaternary ammonium salt, an alkylamine, an octadecyltrimethylammonium chloride, an alkyl dimethylphenyl ammonium chloride, an alkyl hydroxyethyl dimethylammonium chloride, and an alkylamidodimethyl propylamine.

In other embodiments, the anionic surfactant includes one or more of a carboxylate, a phosphate, a sulfate, a sulfonate, or a glutamine. In certain embodiments, the anionic surfactants include one or more of an ammonium lauryl sulfate, a sodium laureth sulfate, a sodium lauryl sarcosinate, an ammonium laureth sulfate, and a sodium stearate.

In yet other embodiments, the nonionic surfactant includes one or more of an amine oxide, an ether type surfactant (e.g., crown ethers, glucosyl dialkyl ethers, polyglycerol alkyl ethers, or polyoxyethylene alkyl ethers), a hexadecyl alcohol laurate, or a sorbitan monolaurate. In some examples, the nonionic surfactants include one or more of an ethoxylate, an alkoxylates, a cocamide, a docusate (e.g., dioctyl sodium sulfosuccinate), and a perfluorooctanesulfonate.

In certain embodiments, the cleaning chemical 105 includes one or more secondary components such as chelating agents, corrosion inhibitors, and acids and bases that are optionally added to further control surface tension, scavenge metals, inhibit oxidative side reactions, and control pH. In certain examples, the chelating agents include organic molecules including a bidentate, a tetradentate, a hexadentate, or an octadentate.

In the example of FIG. 1, an adjustable pump is provided to control the flow of cleaning chemical 105 out of the storage container 103. In certain embodiments, the adjustable pump is a solenoid pump 111 that is operably controllable to open and close a solenoid valve. In certain embodiments, an electrical current flows through a coil of the solenoid pump 111 to generate a magnetic field that pulls or pushes a plunger or piston for opening and closing the valve. When the valve is opened, the chemical cleaner 105 can flow past the plunger or piston. When the valve is closed, the chemical cleaner 105 is blocked from exiting the pump. In certain embodiments, the plunger or piston is a movable part that is connected to the core of the coil. When the coil is activated, the magnetic force created by the coil moves the core, which in turn moves the plunger or piston. The plunger or piston is responsible for opening and closing the valve, which controls the flow of chemical cleaner 105 from the pump 111. The valve regulates the flow of fluid and includes a housing that contains a seat and a diaphragm. In certain embodiments, the solenoid valve includes PTFE or PVC to protect against corrosion caused by the cleaning chemical 105. When the plunger or piston moves, it opens or closes the valve, allowing the cleaning chemical 105 to pass through or preventing backflow. The valve is designed to be a one-way system, ensuring that the fluid flows in the desired direction (i.e., directional arrow A).

The solenoid pump 111 includes an inlet and outlet that are the points where the cleaning chemical 105 enters and exits the solenoid pump 111. In certain embodiments, the inlet is located at the bottom of the solenoid pump 111 (closer to the storage container 103), where fluid is drawn into the solenoid pump 111 from the storage container 103 through a filter or screen. The outlet is located at the top of the solenoid pump 111, where the cleaning chemical 105 is discharged. In certain examples, the cleaning chemical 105 is supplied at a rate of 0.01 to 20 liters/minute.

The foaming nozzle apparatus 101 further includes a source or supply 113 of water and gas flowing in a direction shown by directional arrow B. In certain embodiments, an inert gas including nitrogen (N₂) is mixed with water. In other embodiments, inert gases selected from helium, neon, argon, or xenon are combined with water. The inert gases are used to help reduce corrosion, such as oxidation, from forming on wafer surfaces during cleaning. In yet other embodiments, low-humidity air is combined with water. In certain embodiments, the supply 113 includes an air desiccant, such as a hygroscopic silica gel or activated alumina, to reduce the humidity of the air. In some embodiments, the mixture of water and gas is supplied at a rate of 0.01 to 20 liters/minute through the passageway 115. In some embodiments, the gas is dispersed at a pressure of 40 psi or less.

As shown in FIG. 1, the output 109 intersects the passageway 115 allowing the water and gas to combine with the cleaning chemical 105 to form a mixture 117. In some embodiments, the passageway 115 is a tube or pipe. In certain examples, the output 109 is a tube or pipe, and a fitting or joint is used to connect the output 109 with the passageway 115. In certain embodiments, the diameter of the tube or pipe ranges between 9.5 millimeters (mm) to 12 mm. The mixture 117 is propelled into a foaming device 118 wherein the mixture 117 is formed into a foam mixture 117′. The foam mixture 117′ is then passed through a nozzle 119 and ejected through an aperture of the nozzle 119 as a foaming cleaning agent 121. In certain embodiments, the foaming device 118 includes a high-density foam sponge, a medium-density foam sponge, or a low-density foam sponge. In certain embodiments, the foaming device 118 is a vessel configured to adjust the pressure of the mixture 117 to allow the formation of the foam mixture 117′. The foam mixture 117′ is passed through a stainless steel wire mesh of the foaming device before entering the nozzle 119.

In certain embodiments, the foaming cleaning agent 121 is a foam including an agglomeration of gas bubbles separated from one another by a thin liquid film. A bubble formation of the foam removes undesired debris and contaminants from the surface of a wafer 201 through the movement of the liquid film between the undesired debris and contaminants and the surface of the wafer 201 so that the resulting buoyancy lifts away undesired debris and contaminants. In certain embodiments, scrubbing removes undesired matter from the surface of the wafer 201 through the movement of the liquid in a manner that creates surface tension differences that give rise to a force during the movement of the liquid film. Moreover, bubble-bursting energy significantly complements the cleaning power of the foaming cleaning agent 121.

The supply 113 of gas and water relative to the supply of the cleaning chemical 105 is at an angle θ of between 1 degree and 180 degrees. As shown in FIG. 1, the supply 113 of gas and water relative to the supply of the cleaning chemical 105 is at an angle θ of 90 degrees.

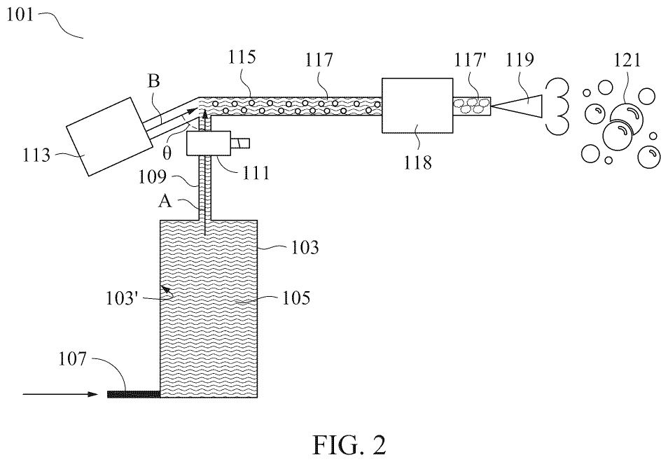

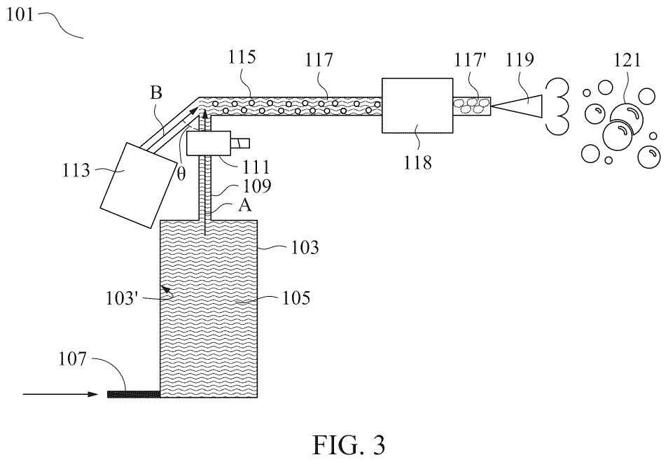

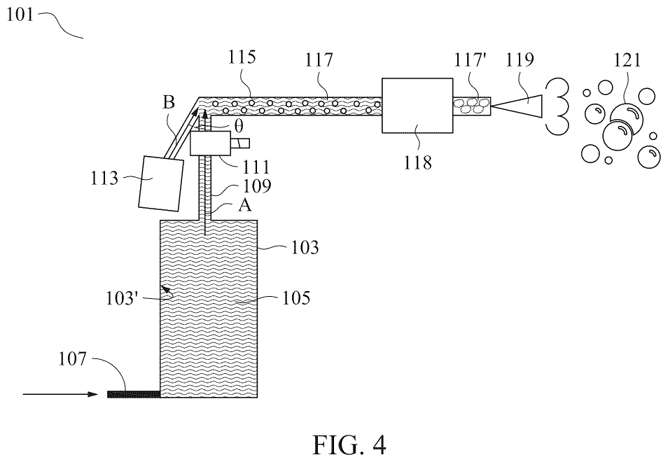

In certain embodiments, the position of the supply 113 of gas and water is adjustable to provide the desired angle. In the example of FIG. 2, the supply 113 of gas and water relative to the supply of the cleaning chemical 105 is at an angle θ of 60 degrees. In other embodiments, as shown in FIG. 3, the supply 113 of gas and water relative to the supply of the cleaning chemical 105 is at an angle θ of 45 degrees. In the example of FIG. 4, the supply 113 of gas and water relative to the supply of the cleaning chemical 105 is at an angle θ of 30 degrees.

In the embodiments of the present disclosure, the angle θ is adjustable between 1 degree and 180 degrees to control the amount of shearing force generated by the mixture of gas and liquid. Depending on the type of wafer surface being cleaned, the spray force is adjusted so that the structures on the wafer surfaces, such as sidewalls and trenches, are not compromised or damaged by too high of a shear stress. The spray force is at its highest level when the angle θ is at 90 degrees. In embodiments of the present disclosure, the spray force is sufficient to produce shear stress and turbulent flow for cleaning the contaminants from sidewalls and bottoms of trenches and vias without damaging these structures.

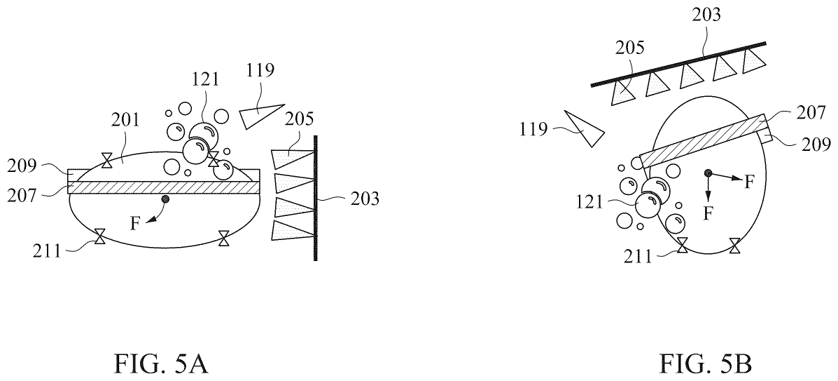

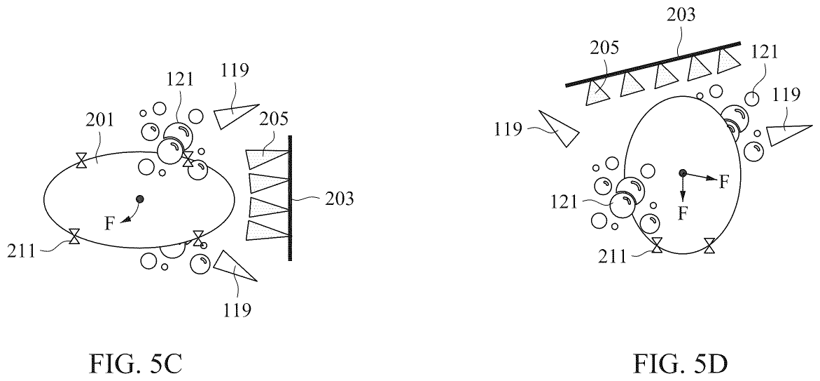

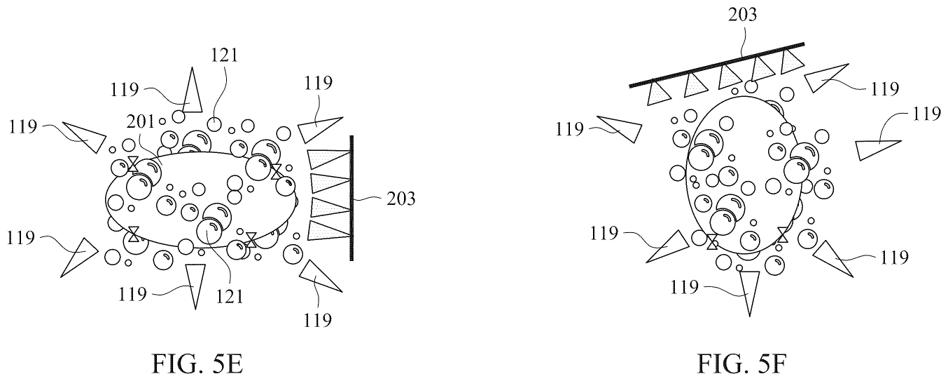

FIG. 5A shows an example of the foaming nozzle apparatus 101 installed together with a brush cleaner including a pair of brushes 207/209 positioned on opposite sides of a horizontally positioned wafer 201. For the sake of simplicity, only the nozzle 119 of the foaming nozzle apparatus 101 is shown in FIG. 5A. In this example, at least one spray bar 203 is provided and includes a plurality of spray nozzles 205. The wafer 201 is held in position by a plurality of grooved rollers such as chuck rollers 211 in a cleaning or polishing chamber. The rotation of the wafer 201 generates a centrifugal force from the center of the wafer to the outer edge of the wafer, as shown by directional arrow F.

In certain embodiments, the foaming nozzle apparatus 101 is installed in a chamber at various stages of a wafer transfer pathway. In certain embodiments, the foaming nozzle apparatus 101 is installed in a vertical pre-clean chamber or a horizontal pre-clean chamber. In other embodiments, the foaming nozzle apparatus 101 is installed in a pencil cleaning, double pencil cleaning, sponge cleaning, or brush cleaning chamber. In other embodiments, the foaming nozzle apparatus 101 is installed in a polishing chamber. In other embodiments, a head rinsing step is performed by the foaming nozzle apparatus 101 both before and after the CMP of the wafer. In yet other embodiments, a pad rinse of a pad conditioning arm is performed with the foaming nozzle apparatus 101 both before and after polishing is performed.

In the example of FIG. 5A, the foaming nozzle apparatus 101 delivers the foaming cleaning agent 121 to at least one of the surfaces of the wafer 201. As the wafer 201 rotates, the foaming cleaning agent 121 is delivered uniformly across an entirety of one or more surfaces of the wafer 201. In certain embodiments, the wafer rotates at a speed of 500 rotations per minute (rpm) or less. The foaming cleaning agent 121 is a viscous foam dispersed across the surface(s) of the wafer 201, trapping and holding debris and/or contaminants until rinsing off the wafer 201. In certain embodiments, the viscosity of the foaming cleaning agent is between 100 and 10,000 centipoise.

The brushes 207/209 may, for example, be porous and/or sponge-like, and/or may be made of a resilient material such as nylon or polyvinyl acetate (PVA). In certain embodiments, the brushes are in the shape of a roller. During the scrubbing process, each brush 207/209 is rotatably mounted, and the two brushes 207/209 may be driven by a drive mechanism (for example a motor) or mechanisms to move horizontally along the surface of the wafer 201 and rotate/scrub over both surfaces of the wafer 201. In some embodiments, the scrubbing force applied to the wafer 201, is adjustable by moving the brushes 207/209 closer and further from the surfaces of the wafer 201 via the drive mechanism. In the example of FIG. 5A, the brushes 207/209 are operational following the application of the foaming cleaning agent 121. The foaming cleaning agent 121 removes debris and/or contaminants from the surface(s) of the wafer 201. The debris and/or contaminants adhere to the foaming cleaning agent. The scrubbing action of the brushes 207/209 further facilitates the removal of the debris, particles, and/or contaminants from the wafer 201.

In some embodiments, following the scrubbing of the foaming cleaning agent 121 on the surface(s) of the wafer 201 by the brushes 207/209, the spray bar 203 rinses the foaming cleaning agent 121 from the wafer 201 and brushes 207/209 with ultra-pure or deionized water. In some embodiments, a first spray bar 203 faces the first surface of the wafer 201 and a second spray bar 203 faces a second surface (opposite the first surface) of the wafer 201. In certain embodiments, the water is ejected onto the wafer by way of a plurality of nozzles 205. The bubbles of the foam act to lift and suspend debris and/or contaminants trapped in trenches, grooves, or recesses, thereby reducing the occurrence of defects. Moreover, the viscous foaming cleaning agent 121 conforms tightly to the surface(s) of the wafer to enhance cleaning efficiency.

FIG. 5B shows another example of the foaming nozzle apparatus 101 installed together with a brush cleaner including a pair of brushes 207/209 positioned on opposite sides of a vertically positioned wafer 201. In the embodiment of FIG. 5B, the wafer 201 is vertically supported by chuck rollers 211 in a chamber. The rotation of the wafer 201 generates a centrifugal force from the center of the wafer to the outer edge of the wafer, as shown by directional arrows F. For the sake of simplicity, only the nozzle 119 of the foaming nozzle apparatus 101 is shown in FIG. 5B. At least one spray bar 203 is provided and includes a plurality of spray nozzles 205.

In the embodiment of FIG. 5B, the foaming nozzle apparatus 101 delivers the foaming cleaning agent 121 to at least one surface of the wafer 201. As the wafer 201 rotates, the foaming cleaning agent 121 is delivered uniformly across an entirety of one or more of the surfaces of the wafer 201. The foaming cleaning agent 121 is a viscous foam discharged across the surface(s) of the wafer 201, trapping and holding debris and/or contaminants until rinsed off the wafer by spray bar 203. In certain embodiments, the foaming cleaning agent includes one or more surfactants which are characterized by having both hydrophobic and hydrophilic groups permitting the surfactants to entrap or envelop debris or contaminants. The trapped debris or contaminants are then rinsed away by the spray bar 203.

In some embodiments, the brushes 207/209 are porous and/or sponge-like, and/or may be made of a resilient material such as nylon or polyvinyl acetate (PVA). During the scrubbing process, each brush 207/209 is rotatably mounted, and the two brushes 207/209 may be driven by a drive mechanism (for example a motor) or mechanisms to move vertically along the surface(s) of the wafer 201 and rotate/scrub over surface(s) of the wafer 201. In some embodiments, the scrubbing force applied to the wafer 201, is adjustable by moving the brushes 207/209 closer and further from the surfaces of the wafer 201 via the drive mechanism. In the example of FIG. 5B, the brushes are operational following the application of the foaming cleaning agent 121. The foaming cleaning agent 121 removes debris and/or contaminants from the surface(s) of the wafer 201. The particles and contaminants adhere to the foaming cleaning agent. The scrubbing action of the brushes 207/209 further facilitates the removal of the debris and/or contaminants from the wafer 201.

In the embodiment of FIG. 5B, following the scrubbing of the foaming cleaning agent 121 on the surface(s) of the wafer 201 by the brushes 207/209, at least one spray bar 203 rinses the foaming cleaning agent 121 from the wafer 201 and brushes 207/209 with ultra-pure or deionized water. In certain embodiments, the water is ejected onto the wafer by way of a plurality of nozzles 205. The bubbles of the foam act to lift and suspend debris and/or contaminants trapped in trenches, grooves, or recesses, thereby reducing the occurrence of defects. Moreover, the viscous foaming cleaning agent 121 conforms tightly to the surface(s) of the wafer to enhance cleaning efficiency.

In other embodiments, both the number and placement of the foaming nozzle apparatuses 101 can vary. In the embodiment of FIG. 5C, two foaming nozzle apparatuses 101 are provided. Again, only the nozzles 119 of the foaming nozzle apparatuses 101 are shown for the sake of simplicity. In the embodiment of FIG. 5C, one of the foaming nozzle apparatuses 101 is positioned facing the first surface of the horizontal wafer 201, and a second foaming nozzle apparatus 101 is positioned facing the second surface (opposite the first surface) of the horizontal wafer 201. In certain embodiments, the spray bar 203 is positioned such that both surfaces of the wafer 201 can be rinsed clean with water.

In other embodiments, as shown in FIG. 5D, two foaming nozzle apparatuses 101 are provided. Only the nozzles 119 of the foaming nozzle apparatuses 101 are shown for the sake of simplicity. In the embodiment of FIG. 5D, one of the foaming nozzle apparatuses 101 is positioned facing the first surface of the vertical wafer 201, and a second foaming nozzle apparatus 101 is positioned facing the second surface (opposite the first surface) of the vertical wafer 201. In certain embodiments, the spray bar 203 is positioned such that both surfaces of the wafer 201 can be rinsed with water.

In the embodiments of FIGS. 5C and 5D, the scrubbing brushes 207/209 of FIGS. 5A and 5B are optional. The spray force in the embodiments of FIGS. 5C and 5D are sufficient to produce shear stress and turbulent flow for cleaning the debris and/or contaminants from sidewalls and bottoms of trenches and vias on both sides of the wafer 201.

FIGS. 5E and 5F illustrate further embodiments of the present disclosure. In FIG. 5E, a plurality of foaming nozzle apparatuses 101 are positioned around the horizontal wafer 201. The plurality of foaming nozzle apparatuses 101 in the embodiment of FIG. 5E provides a uniform distribution of foaming cleaning agent 121 on both surfaces of the horizontal wafer 201. Similarly, in the embodiment of FIG. 5F, a plurality of foaming nozzle apparatuses 101 are positioned around the vertical wafer 201. The plurality of foaming nozzle apparatuses 101 in the embodiment of FIG. 5F provides a uniform distribution of foaming cleaning agent 121 on both surfaces of the vertically oriented wafer 201.

In the embodiments of FIGS. 5E and 5F, the scrubbing brushes 207/209 of FIGS. 5A and 5B are optional. The spray force in the embodiments of FIGS. 5E and 5F are sufficient to produce shear stress and turbulent flow for cleaning the debris and/or contaminants from sidewalls and bottoms of trenches and vias on both sides of the vertically oriented wafer 201.

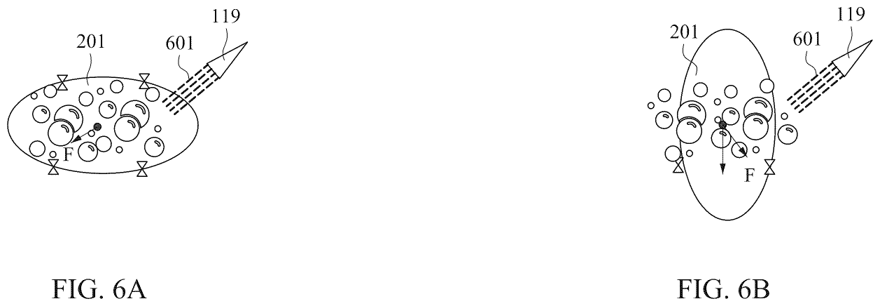

In the embodiment of FIG. 6A, a foaming nozzle apparatus 101 distributes the foaming cleaning agent 121 on at least one surface of the horizontally oriented wafer 201. In the embodiment of FIG. 6B, a foaming nozzle apparatus 101 distributes the foaming cleaning agent 121 on at least one surface of the vertically oriented wafer 201. The foaming cleaning agent 121 is applied to at least one surface of the wafer 201. Sufficient time is allotted to permit the debris and/or contaminants on the surface(s) of the wafer 201 to be drawn out into the foaming cleaning agent 121. In certain embodiments, the foaming cleaning agent 121 is left on the surface of the wafer for about 5 seconds to about 300 seconds. In other embodiments, the foaming cleaning agent 121 is left on the surface of the wafer for about 30 seconds to about 300 seconds. In some embodiments, the foaming nozzle apparatus 101 is configured to adjust the solenoid pump 111 (FIG. 1) to preclude the cleaning chemical 105 from passing through the solenoid pump 111. As a result, a water and gas mixture 601 is ejected from nozzle 119 to rinse the foaming cleaning agent 121 from the surface(s) of the wafer 201. In other embodiments, only water is supplied for rinsing away the foaming cleaning agent 121. More than one foaming nozzle apparatus 101 is positioned around the wafer 201 in some embodiments. Moreover, in other embodiments, one or more scrubbing brushes 207/209 (FIGS. 5A and 5B) are provided for scrubbing the surface(s) of the wafer after the foaming cleaning agent 121 is applied to the surface(s) of the wafer 201.

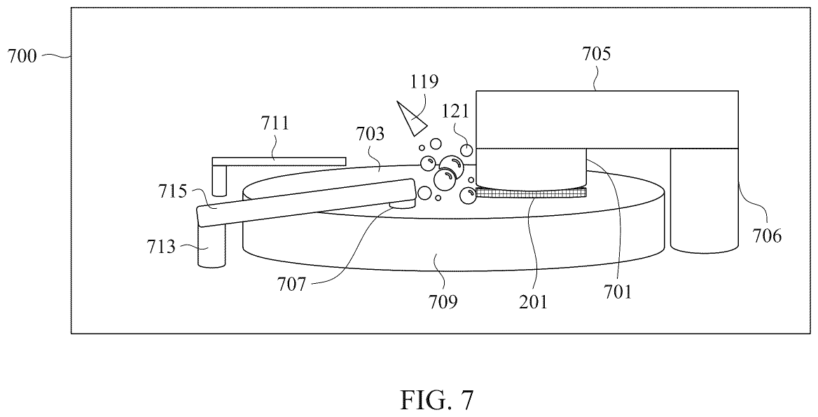

As shown in the embodiment of FIG. 7, the foaming nozzle apparatus 101, represented by way of nozzle 119, is included in a polishing chamber 700. The polishing chamber 700 includes a polishing head 701 that applies pressure to the wafer 201 against the surface of the polishing pad 703 through a wafer carrier and support arm 705 and motor 706. The polishing pad 703 is secured to a rotating, orbital, or linear platen 709. In certain embodiments, the platen rotates at a speed of 500 rpm or less. In certain embodiments, a slurry arm 711 disperses a stream of polishing slurry containing an oxidizer, abrasive, and/or ultra-pure water distributed on the surface of the polishing pad 703 and in cooperation with the rotating motion of wafer 201 acts to remove surface unevenness on the wafer 201 after each layer of integrated circuitry is formed. A pad conditioning device 707 operates to restore and maintain the surface of the polishing pad 703 as it is worn down by the polishing action. A motor 713 pivots end effector arm 715 in an arc about a fixed shaft while simultaneously providing rotational motion and a downward force to pad conditioning device 707.

In the embodiment of FIG. 7, at least one foaming nozzle apparatus 101 is provided in the polishing chamber 700 along with other components of the polishing system. The foaming nozzle apparatus 101 is configured to operate and supply the foaming cleaning agent 121 prior to the start of the polishing process and/or after completion of the polishing process. The at least one foaming nozzle apparatus 101, in the embodiment of FIG. 7, is positioned such that the foaming cleaning agent 121 is dispersed adjacent to the polishing head 701. The foaming cleaning agent 121 cleans the debris and/or contaminants from the surface of the wafer 201 and removes the slurry from the surface of the polishing pad 703.

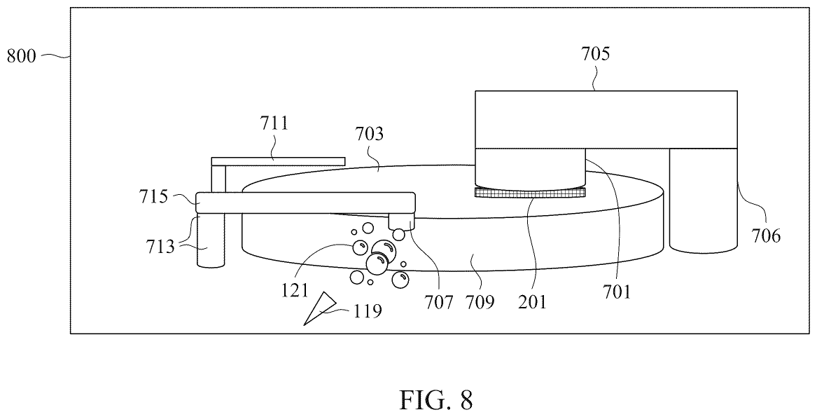

In the embodiment of FIG. 8, the foaming nozzle apparatus 101, represented by nozzle 119, is included in a polishing chamber 800. The pad conditioning device 707 operates to restore and maintain the surface of the polishing pad 703 as it is worn down by the polishing action. In the embodiment of FIG. 8, the pad conditioning device 707 is cleaned by the foaming nozzle apparatus 101. In certain embodiments, a diamond or metal grit is used on the pad conditioning device 707 to facilitate the restoration and maintenance of the surface of the polishing pad 703. The foaming cleaning agent 121 facilitates the removal of debris, contaminants, and/or slurry from the pad conditioning device 707. In other embodiments, the foaming cleaning agent 121 is dispersed on other components inside the polishing chamber for cleaning.

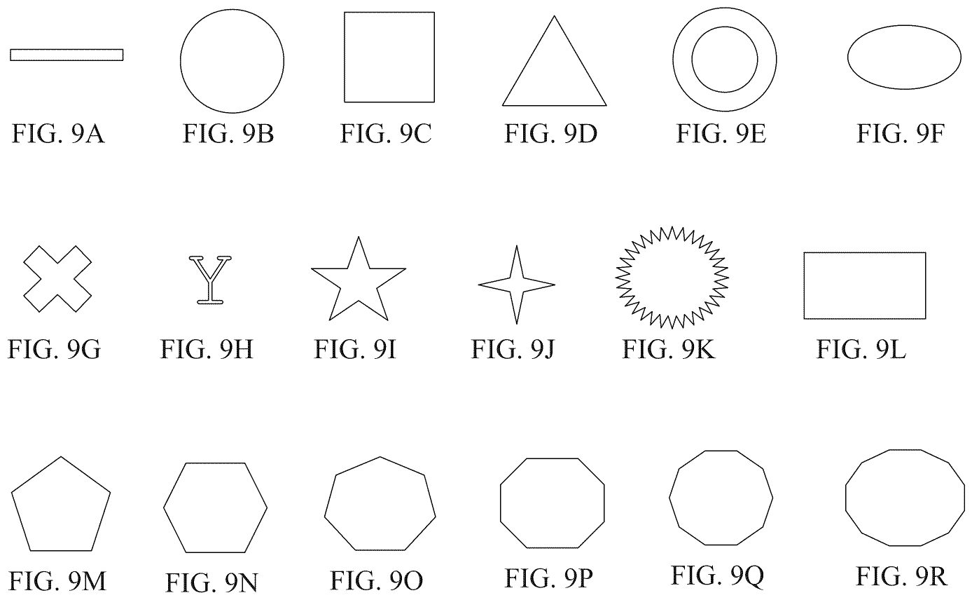

The shape of the aperture of the nozzle 119 of the foaming nozzle apparatus 101 is not limited to any particular number, shape, or size. As shown in the embodiment of FIG. 9A, the aperture of nozzle 119 is in the shape of a slit or line. As shown in the embodiment of FIG. 9B, the aperture of nozzle 119 is in the shape of a circle. In the embodiment of FIG. 9C, the aperture of nozzle 119 is in the shape of a square. In the embodiment of FIG. 9D, the aperture of nozzle 119 is in the shape of a triangle. Although not shown, in other embodiments, the shape of the aperture is selected from a rectangle, pentagon, hexagon, heptagon, octagon, or decagon. In the embodiment of FIG. 9E, the aperture is in the shape of a ring. In the embodiment of FIG. 9F, the aperture is in the shape of an oval. FIG. 9G shows an example of an aperture having an X shape. In the embodiment of FIG. 9H, the aperture is in the shape of a Y. FIG. 9I shows an example of an aperture having a star shape. In the embodiment of FIG. 9K, the aperture has a starburst shape. In the embodiment of FIG. 9L, the aperture has a rectangle shape. In the embodiment of FIG. 9M, the aperture has a pentagon shape. In the embodiment of FIG. 9N, the aperture has a hexagon shape. In the embodiment of FIG. 9O, the aperture has a heptagon shape. In the embodiment of FIG. 9P, the aperture has an octagon shape. In the embodiment of FIG. 9Q, the aperture has a decagon shape. In the embodiment of FIG. 9R, the aperture has a dodecagon shape. In other embodiments, more than one aperture is provided in the nozzle 119. In yet other embodiments, a plurality of different aperture shapes are used. Moreover, in the foregoing embodiments using more than one foaming nozzle apparatus 101, each of the nozzles 119 can have the same or different shapes for the aperture.

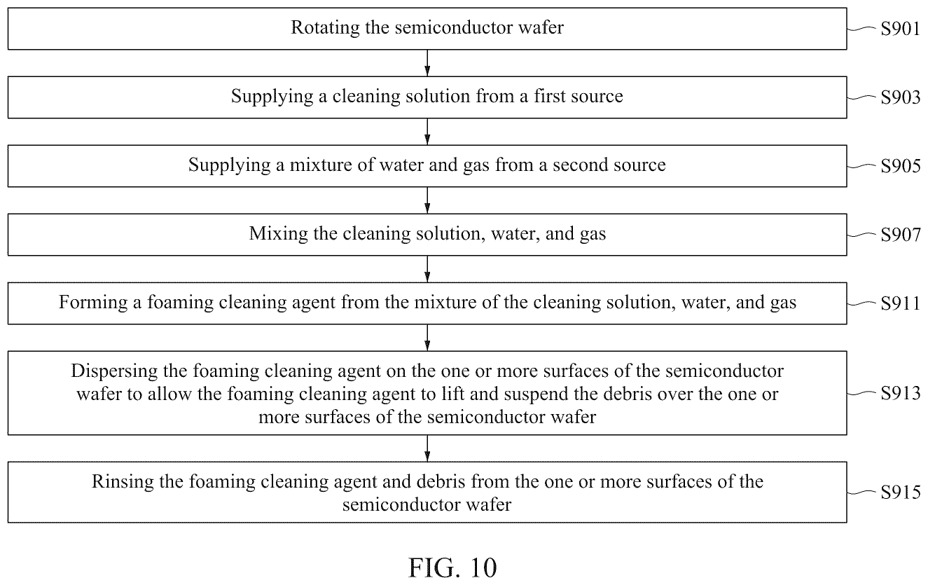

FIG. 10 is a flowchart of a cleaning method of removing debris from one or more surfaces of a semiconductor wafer, in accordance with an embodiment of the present disclosure. The method includes rotating the semiconductor wafer 201 (S901). A cleaning solution 105 is supplied from a first source 103 (S903). A mixture of water and gas is supplied from a second source 113 (S905). The cleaning solution, water, and gas are mixed 117 (S907). A foaming cleaning agent 121 is formed from the mixture 117 of the cleaning solution, water, and gas (S911). The foaming cleaning agent 121 is dispersed on the one or more surfaces of the semiconductor wafer 201 to allow the foaming cleaning agent 121 to lift and suspend the debris over the one or more surfaces of the semiconductor wafer 201 (S913). The foaming cleaning agent 121 and debris are rinsed from the one or more surfaces of the semiconductor wafer 201 (S915). It is understood that in some embodiments, additional processes are performed before, during, or after the steps of the cleaning method. For reasons of simplicity, additional steps are not discussed herein in detail.

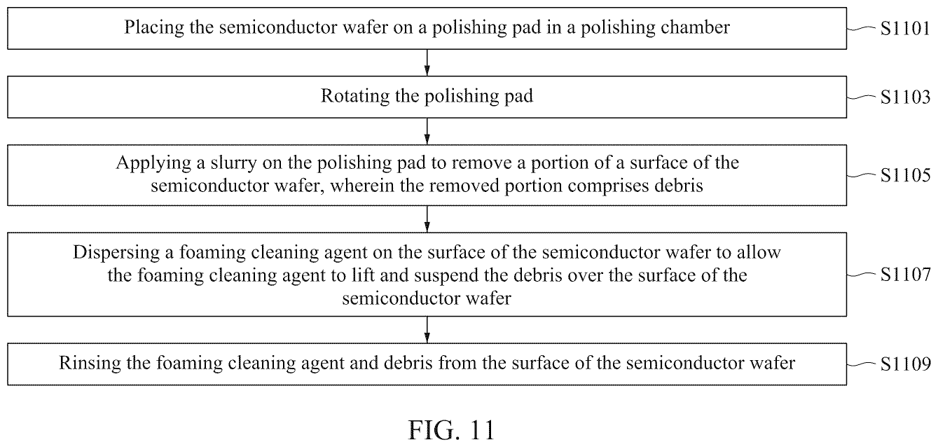

FIG. 11 is a flowchart of a method of cleaning a semiconductor wafer in accordance with an embodiment of the present disclosure. The method includes placing the semiconductor wafer 201 on a polishing pad 703 in a polishing chamber 700 (S1101). The polishing pad 703 is rotated (S1103). A slurry is applied on the polishing pad 703 to remove a portion of a surface of the semiconductor wafer 201, wherein the removed portion comprises debris (S1105). A foaming cleaning agent 121 is dispersed on the surface of the semiconductor wafer 201 to allow the foaming cleaning agent 121 to lift and suspend the debris over the surface of the semiconductor wafer 201 (S1107). The foaming cleaning agent 121 and debris from the surface of the semiconductor wafer 201 are rinsed (S1109). It is understood that in some embodiments, additional processes are performed before, during, or after the steps of the method. For reasons of simplicity, additional steps are not discussed herein in detail.

In summary, the present disclosure provides a foaming nozzle apparatus configured to disperse a foaming cleaning agent that efficiently removes debris and/or contaminants from wafer surface(s). In other embodiments, the foaming nozzle apparatus is configured to disperse a foaming cleaning agent that removes debris and/or contaminants from wafer processing equipment in a polishing chamber. The foaming cleaning agent is dispersed in a rapid, uniform manner across the entirety of the wafer surface(s) and remains on the surface(s) of the wafer for longer periods of time to enhance cleaning results. Smaller amounts of the cleaning chemical are used since the foaming cleaning agent remains on the surface(s) of the wafer for longer periods of time. It is understood, however, that other embodiments may offer additional advantages and not all advantages are necessarily disclosed herein, and that no particular advantage is required for all embodiments.

In certain embodiments, a method of removing debris from one or more surfaces of a semiconductor wafer is provided. The method includes rotating the semiconductor wafer. A cleaning solution is supplied from a first source. A mixture of water and gas is supplied from a second source. The cleaning solution, water, and gas are mixed. A foaming cleaning agent is formed from the mixture of the cleaning solution, water, and gas. The foaming cleaning agent is dispersed on the one or more surfaces of the semiconductor wafer to allow the foaming cleaning agent to lift and suspend the debris over the one or more surfaces of the semiconductor wafer. The foaming cleaning agent and debris are rinsed from the one or more surfaces of the semiconductor wafer.

In some embodiments, the cleaning solution includes one or more surfactants. In other embodiments, the gas includes an inert gas selected from nitrogen, helium, neon, argon, or xenon. In certain embodiments, the cleaning solution is supplied at a rate of 0.01 to 20 liters/minute. In other embodiments, the semiconductor wafer is rotated in a vertical orientation. In yet other embodiments, the semiconductor wafer is rotated in a horizontal orientation. In further embodiments, the semiconductor wafer is rotated inside a semiconductor polishing or semiconductor cleaning chamber. Other embodiments include scrubbing the foaming cleaning agent on the one or more surfaces of the semiconductor wafer with one or more brushes. Further embodiments include the foaming cleaning agent being dispersed from a first nozzle facing a first surface of the semiconductor wafer and a second nozzle facing a second surface of the semiconductor wafer opposite the first surface.

In other embodiments, a method of cleaning a semiconductor wafer is provided. The method includes placing the semiconductor wafer on a polishing pad in a polishing chamber. The method includes rotating the polishing pad. A slurry is applied on the polishing pad to remove a portion of a surface of the semiconductor wafer. The removed portion includes debris. A foaming cleaning agent is dispersed on the surface of the semiconductor wafer to allow the foaming cleaning agent to lift and suspend the debris over the surface of the semiconductor wafer. The foaming cleaning agent and debris from the surface of the semiconductor wafer are rinsed.

In some embodiments, the foaming cleaning agent includes at least one surfactant. In other embodiments, the polishing pad is rotated at a speed of 500 rpm or less. In further embodiments, the slurry is applied through a slurry arm disposed over the polishing pad. Other embodiments include the foaming cleaning agent being dispersed through a plurality of nozzles. In other embodiments, the semiconductor wafer is placed on the polishing pad by a polishing head. In other embodiments, the foaming cleaning agent has a viscosity between 100 and 10,000 centipoise.

In yet other embodiments, an apparatus for removing debris from a semiconductor wafer is provided. The apparatus includes a plurality of grooved rollers configured to rotate the semiconductor wafer. At least one foam source is configured to disperse a foaming cleaning agent. At least one scrubbing brush is configured to scrub at least one surface of the semiconductor wafer. At least one spray bar is configured to rinse the semiconductor wafer.

In some embodiments, the at least one scrubbing brush includes a nylon or polyvinyl acetate (PVA). In other embodiments, the at least one spray bar includes a plurality of nozzles. In yet other embodiments, the at least one foam source is configured to disperse the foaming cleaning agent through a nozzle.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure and that they may make various changes, substitutions, and alterations herein without departing from the spirit and scope of the present disclosure.

What is claimed is:

1. An apparatus for cleaning a semiconductor wafer, comprising:
a storage container configured to hold a cleaning chemical, wherein an inner surface of the storage container includes a coating selected from the group consisting of polytetrafluoroethylene (PTFE), silicon carbide (SiC), and quartz;
a supply of a mixture of water and a gas; and
a nozzle configured to disperse a foaming cleaning agent comprised of the cleaning chemical and the mixture of water and gas.

2. The apparatus of claim 1, wherein the gas is an inert gas selected from the group consisting of nitrogen, helium, neon, argon, and xenon.

3. The apparatus of claim 1, further comprising a solenoid pump disposed between the storage container and the nozzle, the solenoid pump configured to control a flow of the cleaning chemical.

4. The apparatus of claim 3, wherein the solenoid pump comprises a valve including PTFE or polyvinyl chloride (PVC).

5. The apparatus of claim 1, further comprising a foaming device disposed between the storage container and the nozzle, the foaming device including a foam sponge.

6. The apparatus of claim 3, wherein the solenoid pump is disposed between the supply of the mixture of water and gas and the nozzle.

7. The apparatus of claim 1, wherein the cleaning chemical comprises at least one surfactant selected from the group consisting of an anionic surfactant, a cationic surfactant, and a nonionic surfactant.

8. The apparatus of claim 1, wherein the nozzle comprises an aperture having a shape selected from the group consisting of a slit, a circle, a square, a triangle, and a star.

9. An apparatus for cleaning a pad conditioning device within a polishing chamber, the apparatus comprising:
a source of a cleaning solution;
a source of a mixture of water and gas;
a foaming device configured to form a foaming cleaning agent from the cleaning solution and the mixture of water and gas; and
a nozzle configured to disperse the foaming cleaning agent onto the pad conditioning device.

10. The apparatus of claim 9, wherein the pad conditioning device comprises a diamond or metal grit.

11. The apparatus of claim 9, wherein the nozzle comprises an aperture having a shape selected from the group consisting of a slit, a circle, a square, a triangle, and a star.

12. The apparatus of claim 9, wherein the foaming cleaning agent has a viscosity between 100 and 10,000 centipoise.

13. The apparatus of claim 9, wherein the foaming device is configured to adjust a pressure of the cleaning solution and the mixture of water and gas to form the foaming cleaning agent.

14. The apparatus of claim 9, further comprising a polishing pad, wherein the pad conditioning device is configured to restore a surface of the polishing pad.

15. The apparatus of claim 9, wherein the cleaning solution is maintained at a temperature between 25 °C and 80 °C.

16. The apparatus of claim 9, further comprising a second nozzle configured to rinse the foaming cleaning agent from the pad conditioning device.

17. An apparatus for removing debris from a semiconductor wafer, comprising:
a plurality of grooved rollers configured to rotate the semiconductor wafer;
at least one foam source configured to disperse a foaming cleaning agent;
at least one scrubbing brush configured to scrub at least one surface of the semiconductor wafer; and
at least one spray bar configured to rinse the semiconductor wafer.

18. The apparatus of claim 17, wherein the at least one scrubbing brush comprises a nylon or polyvinyl acetate (PVA).

19. The apparatus of claim 17, wherein the at least one spray bar includes a plurality of nozzles.

20. The apparatus of claim 17, wherein the at least one foam source is configured to disperse the foaming cleaning agent through a nozzle.
